(19) United States
(12) Patent Application Publication
(10) Pub. No.: US 2020/0359603 A1
(43) Pub. Date: Nov. 19, 2020

(54) Dual Safety Dog Leash

(71) Applicant: Matthew P. Rhein, Park Ridge, IL (US)

(72) Inventor: Matthew P. Rhein, Park Ridge, IL (US)

(21) Appl. No.: 16/415,858

(22) Filed: May 17, 2019

(51) Int. Cl. A01K 27/00

(52) U.S. Cl. CPC A01K 27/003; A01K 27/002; A01K 27/005; A01K 27/001

(57) ABSTRACT

This present invention accomplishes combining a standard dog leash which attaches to the dog's collar or harness with a choker leash which goes around the dog's neck. This invention creates one new dual-purpose leash by running the choker inside the hollowed material of the standard leash. This invention combines the ability to handle the dog gently by using a standard leash, but also provides the ability to use the choker to quickly change the dog's behavior if needed.

### FIELD OF THE INVENTION

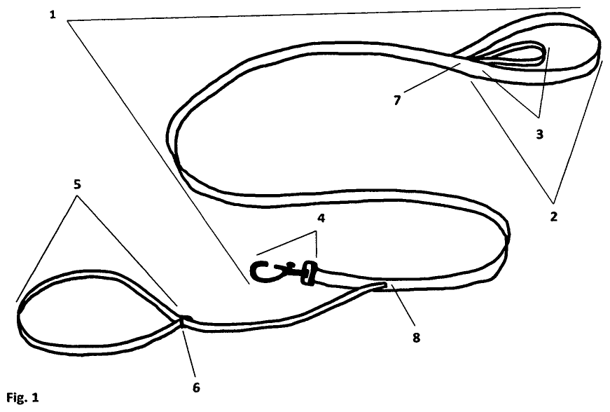

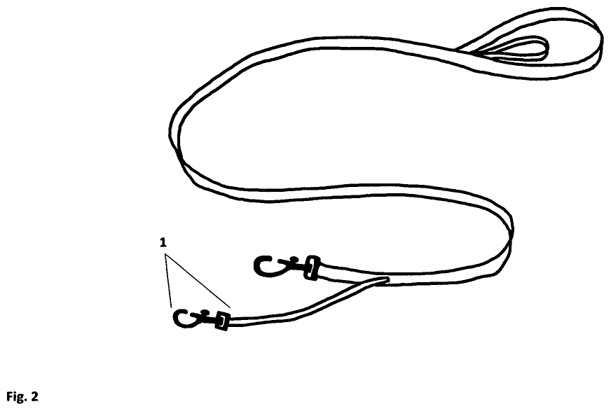

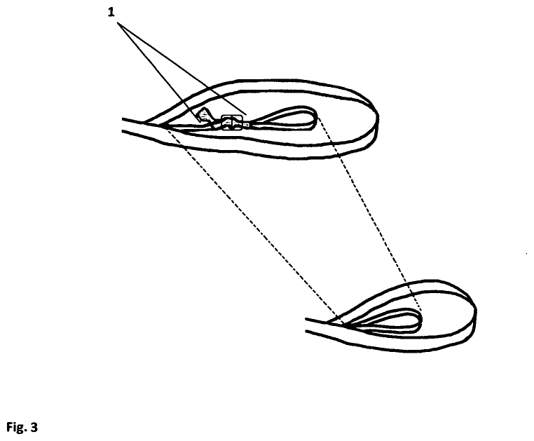

The present disclosure generally relates to dog leashes. It is directed to provide dog owners with more safety and control over their dogs while walking them. A brief description of the drawing in FIG. 1, is an overall view of the dog leash invention. This invention is made up of a dog leash constructed from hollow tubular material, identified in reference 1. At the user end are the leash handle, identified in reference 2 and the choker handle, identified in reference 3. At the dog end are the metal bolt snap, identified in reference 4 and the choker noose, identified in reference 5. The noose is created by securing the dog end of the choker leash material to a ring, identified in reference 6, then passing the choker leash material back through the ring. The length of the standard leash is hollow with the choker leash running through it. The choker leash handle exits the hollow standard leash at the user end, identified in reference 7 and at the dog end, identified in reference 8. The metal bolt snap identified in reference 4 is intended to be fastened to the dog's collar or harness. The choker noose identified in reference 5 is intended to be placed around the dog's neck. This present disclosure has combined two separate leashes into one, so that the dog owner can have the benefit of both types of leash. The result is the gentle handling of dogs, with the added ability to immediately control the dog's behavior. A brief description of the drawing in FIG. 2, is an overall view of the dog leash invention using an optional second metal bolt snap rather than a noose. This present disclosure is also available with a second metal bolt snap, identified in reference 1 for dog owners who choose to use their own choker collar rather than the noose. A brief description of the drawing in FIG. 3, is a magnified view of the dog leash and choker handles, showing an adjustable buckle on the choker. The choker leash handle is made adjustable by including a slide buckle, identified in reference 1 to allow the user to adjust the length of the choker and size of the choker handle.

### BACKGROUND

This invention is used for walking dogs. Today, dog owners usually have either a choker leash for their dog, which many owners feel is too harsh and unkind to the dogs because it strangulates the dog's throat, or they have a standard leash wish attaches to the dog's collar or harness. While using only a choker, dogs often incur injury to their necks from routine pulls on the choker leash when taken for a walk. While using a standard leash, medium to large dogs can become difficult to control at times. Some of the typical scenarios are when they see a car, when they see a squirrel, rabbit, another dog, child on a bicycle and many more. At these times, the normally docile dog can become very excited and pull extremely hard on the leash. When the dog is very excited, it's very hard to control them. Using only a standard leash lacks the ability to immediately change the dog's behavior if needed. With this invention, the owner now has a choker as an option on their leash to bring the dog back into control very quickly. This invention allows the owner to have the peace of mind that they are gently walking their dog, but also the assurance that if an immediate need arises, they can control their dog and keep them, their dog and others safe. Additionally, this new leash will assist dog owners in training their dogs, by correcting bad behaviors more effectively than a standard leash.

1. A dog leash invention comprising:
a dog leash made from a hollow tubular material;
combined with a choker leash running inside through the hollow length of the dog leash material.

2. A dog leash invention as in claim 1, wherein said leashes have two leash handles at the user end, a fixed handle on the dog leash and an adjustable handle on the choker leash.

3. A dog leash invention as in claim 2, wherein said choker leash handle has an adjustable slide buckle.

4. A dog leash invention as in claim 1, wherein said dog leash has a metal bolt snap attached to the dog end of the hollow dog leash material.

5. A dog leash invention as in claim 1, wherein said choker leash has a ring attached to the dog end, used to create a choker noose.

6. A dog leash invention as in claims 1-4, wherein as an option can have a second metal bolt snap secured to the dog end of the choker leash.

7. A dog leash invention as in claims 1-6, wherein can be scaled to the size of the dog.
